(19) United States
(12) Patent Application Publication
(10) Pub. No.: US 2017/0185270 A1
(43) Pub. Date: Jun. 29, 2017

(54) Animation display method for view and terminal device

(71) Applicants: Le Holdings (Beijing) Co., Ltd., Beijing (CN); Le Shi Zhi Xin Electronic Technology (Tianjin) Limited, Tianjin (CN)

(72) Inventor: Jinguang Zheng, Binhai New Area (CN)

(21) Appl. No.: 15/240,090

(22) Filed: Aug. 18, 2016

Related U.S. Application Data
(63) Continuation of application No. PCT/CN2016/089577, filed on Jul. 10, 2016.

(30) Foreign Application Priority Data
Dec. 28, 2015 (CN) 201511019935.5

(51) Int. Cl. G06F 3/0484; G06F 17/21; G06T 13/00

(52) U.S. Cl. CPC G06F 3/04845; G06T 13/00; G06F 17/212

(57) ABSTRACT

The present patent disclosure relates to the field of multimedia technologies and discloses an animation display method and apparatus for a view and an electronic device terminal. Some embodiments of this disclosure include the following steps: adding respective subviews sequentially to a viewgroup; when the subview executes a scale-up animation to trigger the viewgroup to perform a layout, performing the layout in a sequence in which the subviews are added to the viewgroup; and when the respective subviews in the viewgroup are displayed, finally displaying the subview that executes the scale-up animation. Implementation manners of this disclosure can ensure that a subview after executing a scale-up animation would not be covered by another subview and animation display would not be misplaced, ensures an animation display effect of the subview, can enrich interface presentation of the device terminal when being applied to the device terminal, and improves user experience.

### CROSS-REFERENCE TO RELATED APPLICATIONS

The present disclosure is a continuation of PCT application No. PCT/CN2016/089577 submitted on Jul. 10, 2016. The present disclosure claims priority to Chinese Patent Application No. 201511019935.5, entitled “ANIMATION DISPLAY METHOD AND APPARATUS FOR VIEW AND DEVICE TERMINAL” and filed with the Chinese Patent Office on Dec. 28, 2015, which is incorporated herein by reference in its entirety.

### TECHNICAL FIELD

The present disclosure relates to the field of multimedia technologies, and in particular, to an animation display technology for a view.

### BACKGROUND

On an interface of application software, a scale-up animation effect is usually added to enrich interface presentation. Currently, in a process of developing an Android software application, it is usually used that in a viewgroup, after being focused, a subview has some selected effects such as a scale-up animation. After subviews are added to an Android viewgroup, after the measurement and layout are performed, canvas drawing is performed at last according to a subview adding sequence, and a subview that is added later is drawn later.

For example, first, three subviews A, B, and C are added sequentially to a viewgroup (as shown in FIG. 1, a dashed-line frame indicates a view size assigned for each subview, and a solid-line frame indicates an actual size of each subview), but in a process of implementing this disclosure, the inventor finds that after a scale-up animation, the size of the subview A is greater than its original size, and after the animation is completed, a display effect would be covered by the subview B, as shown in FIG. 2. In the prior art, to prevent the subview A from being covered, a Bring To Front method is usually adopted, but the Bring To Front method may cause that display of the subview A is misplaced, the display of the subview A changes to the end, and an effect thereof is shown in FIG. 3.

### SUMMARY

The present disclosure provides an animation display method for a view and an electronic device terminal, so as to ensure that an effect of a scale-up animation executed by a subview is not covered by another subview and after executing the scale-up animation, the subview can be accurately displayed and would not be misplaced while keeping a sequence in which respective subviews are added into a viewgroup unchanged.

According to a first aspect, an implementation manner of the present disclosure provides an animation display method for a view, including the following steps: adding respective subviews sequentially to a viewgroup; when the subview executes a scale-up animation to trigger the viewgroup to perform a layout, performing the layout in a sequence in which the subviews are added to the viewgroup; and when the respective subviews in the viewgroup are displayed, finally displaying the subview that executes the scale-up animation.

According to a second aspect, an embodiment of this disclosure further provides a non-volatile computer storage medium, which stores computer executable instructions, where the computer executable instructions are used to execute any foregoing animation display method for a view of this disclosure. [symbol] device terminal

According to a third aspect, an embodiment of this disclosure further provides an electronic device, including: at least one processor; and a memory communicably connected with the at least one processor for storing instructions executable by the at least one processor, where execution of the instructions by the at least one processor causes the at least one processor to execute any foregoing animation display method for a view of this disclosure.

As compared with the prior art, an implementation manner of this disclosure includes: adding respective subviews sequentially to a viewgroup; when the subview executes a scale-up animation to trigger the viewgroup to perform a layout, performing the layout in a sequence in which the subviews are added to the viewgroup; and particularly, when the respective subviews in the viewgroup are displayed, finally displaying the subview that executes the scale-up animation. An implementation manner of this disclosure can ensure that a scale-up animation executed by a subview is not covered by another subview and the scale-up animation can be accurately displayed and would not be misplaced while keeping a sequence in which respective subviews are added into a viewgroup unchanged. When being applied to a device terminal (for example, an Android intelligent television), the implementation manner of this disclosure can enrich interface display of the device terminal and improve user experience.

In an embodiment, the step of performing the layout in a sequence in which the subviews are added to the viewgroup includes the following sub-step: arranging the subview first added to the viewgroup to the subview last added to the viewgroup sequentially in a same direction inside a canvas frame. Such an approach can maintain original position information of the respective subviews, the arranged sequence of the respective subviews would not change, and when the scale-up animation is displayed, it would not be misplaced.

In an embodiment, the same direction is a direction from the left to the right or the same direction is a direction from the top to the bottom.

In an embodiment, the step of when the respective subviews in the viewgroup are displayed, finally displaying the subview that executes the scale-up animation comprises the following sub-steps: displaying subviews that do not execute a scale-up animation in a sequence in they are added to the viewgroup; and after display of the subviews that do not execute a scale-up animation is completed, displaying the subview that executes the scale-up animation. In this implementation manner, during display, the subviews that do not execute a scale-up animation are displayed first, and after display of the subviews that do not execute a scale-up animation is completed, the subview that executes the scale-up animation is displayed, so as to ensure that the subview that executes the scale-up animation is not covered by a subview that does not execute a scale-up animation.

In an embodiment, the step of adding respective subviews sequentially to a viewgroup includes: adding the respective subviews to a drawing process in a sequence in which the respective subviews are added to the viewgroup; and when the subview executes the scale-up animation to trigger the viewgroup to perform a layout, adjusting an adding sequence of the subview that executes the scale-up animation to the last. In the step of displaying the respective subviews in the viewgroup, the respective subviews in the canvas frame are displayed according to an adding sequence of the respective subviews in the drawing process. This implementation manner may implement that the scale-up animation executed by the subview is not covered by another subview, to ensure a scale-up animation effect.

In an embodiments, before the layout is performed on the respective subviews, the respective subviews are first measured (for example, the measurement on the size); and according to results of the measurement, the layout is performed in a sequence in which the subviews are added to the viewgroup, so as to ensure display effects of the respective subviews.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a schematic diagram of sequentially adding respective subview to a viewgroup in the prior art;

FIG. 2 is an effect diagram illustrating that a display effect of a subview A after a scale-up animation is covered by a subview B in the prior art;

FIG. 3 is an effect diagram illustrating that display of a subview A after executing a scale-up animation is misplaced in the prior art;

FIG. 4 is a flowchart of an animation display method for a view according to a first implementation manner of this disclosure;

FIG. 5 is an effect diagram illustrating that a subview A after executing a scale-up animation is not covered and has a normal display position in the first implementation manner of this disclosure;

FIG. 6 is a schematic structural diagram of an animation display apparatus for a view according to a second implementation manner of this disclosure; and

FIG. 7 is a schematic structural diagram of an electronic device according a fifth implementation manner of this disclosure.

### DETAILED DESCRIPTION

In order to make the objectives, technical solutions, and advantages of this disclosure more comprehensible, the implementation manners of this disclosure are described in detail below with reference to the accompanying drawings. However, it could be understood by a person of ordinary skill in the art, in the implementation manners of this disclosure, many technical details are provided to enable a reader to preferably understand this disclosure. However, even though the technical details and various changes and modifications based on the following implementation manners do not exist, the technical solutions claimed by the claims of this disclosure can still be implemented.

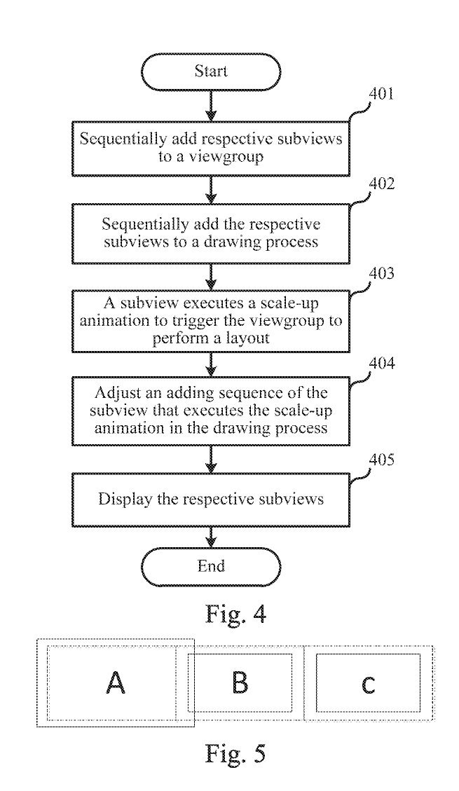

A first implementation manner of this disclosure relates to an animation display method for a view, and a specific process is shown in FIG. 4.

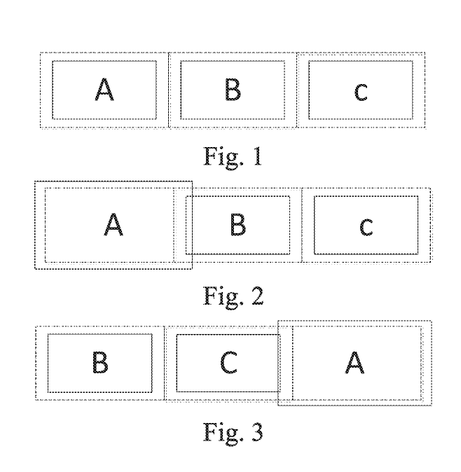

Step 401: A device terminal adds respective subviews sequentially to a viewgroup. In an Android application development process, an animation effect of a user interface (“UI” for short) is indispensable. To implement the animation effect, first, it is necessary to add respective subviews to a viewgroup, that is, sequentially adding the respective subview to an original list. For example, as shown in FIG. 1, respective subviews A, B, and C are sequentially added to an original list of a viewgroup. In FIG. 1, a dashed-line frame indicates a view size assigned for each subview, and a solid-line frame indicates an actual size of each subview. This step is the same the prior art and is not described in detail herein.

Step 402: The device terminal adds the respective subviews to a drawing process in a sequence in which the respective subviews are added to an original list, and at this time, a sequence of arranging the respective subviews in the drawing process is the same the sequence in which the respective subviews are added to the original list of the viewgroup. With regard to the foregoing case, the sequence of the respective subviews in the drawing process is A, B, C.

Step 403: The device terminal performs a measurement and a layout on the respective subviews. Specifically, when the subview executes a scale-up animation and a Bring To Front method, the viewgroup is triggered to perform a measurement (on Measure) and a layout (on Layout). In this step, the measurement and layout are performed according to an adding sequence of the respective subviews in the original list. That is, the layout is performed in a sequence in which respective subviews are added to the original list of the viewgroup to maintain original position information of the respective subviews. During specific implementation, before the layout is performed on the respective subviews, the sizes of the respective subviews may be measured first, and according to results of the measurement, the layout is performed in a sequence in which the respective subviews are added to the original list of the viewgroup. For example, the subview first added to the original list of the viewgroup to the subview last added to the original list of the viewgroup are arranged sequentially in a same direction inside a canvas frame (for example, arranging the respective subviews sequentially in a direction from the left to the right). With regard to the foregoing case, the sequence of the respective subviews in the canvas frame is still A, B, C, so as to ensure that the respective subviews can be normally displayed and would not be misplaced.

Step 404: Adjust an adding sequence of the subview that executes the scale-up animation in the drawing process and adjust the adding sequence of the subview that executes the scale-up animation in the drawing process to the last.

Specifically, an adding sequence of the subview A that executes the scale-up animation in the drawing process is adjusted to the last, that is, at this time, in the drawing process, the sequence of the respective subviews changes from A, B, C to B, C, A. In the drawing process, a subview that is added later is displayed later. Hence, this implementation manner can ensure that the scale-up animation executed by the subview A would not be covered by another subview.

Step 405: The device terminal display the respective subviews. When the respective subviews in the viewgroup are displayed, the subviews that do not execute a scale-up animation are first displayed according to the adding sequence of the respective subviews in the drawing process, and after display of the subviews that do not execute a scale-up animation is completed, the subview that executes the scale-up animation is displayed.

With regard to the foregoing case, the display effect is shown in FIG. 5. In FIG. 5, the device terminal first displays the subviews B and C that do not execute a scale-up animation in the canvas frame according to the adding sequence of the respective subviews in the drawing process, namely, the arranging sequence of B, C, A, and after display of the subviews B and C that do not execute a scale-up animation is completed, the subview A that executes the scale-up animation is displayed.

The foregoing steps may ensure that the subview A after being scaled up is not covered by the subviews B and C, and the subview A would not be misplaced when the scale-up animation is displayed while keeping a sequence in which respective subviews A, B, and C are added into the original list of the viewgroup unchanged. That is, display problems caused by the scale-up animation of the subview in the viewgroup in an Android application development process are resolved.

The step division in the animation display method for a view in the foregoing implementation manners is made merely for clear description, and during implementation, the steps may be combined into one step, or some step may be divided into a plurality of steps, which all fall within the protection scope of the present patent as long as the same logic relationship is included. Either an insignificant modification that is added into the process or insignificant design that is introduced, which does not change the kernel design of the process, falls within the protection scope of the present patent.

A second implementation manner of this disclosure relates to an animation display method for a view. This implementation manner is approximately the same as the first implementation manner and the difference is that: in the first implementation manner of this disclosure, in the step of performing a layout in a sequence in which the subviews are added to the original list of the viewgroup, the layout is performed in a direction from the left to the right, while in the second implementation manner, the subviews are arranged from the top to the bottom. It could be understood by a person skilled in the art that the arrangement direction of the respective subviews may also be directions, which are not listed herein one by one.

Relevant technical details mentioned in the first implementation manner of this disclosure are still effective in this implementation manner, which are not described again herein to reduce repetition.

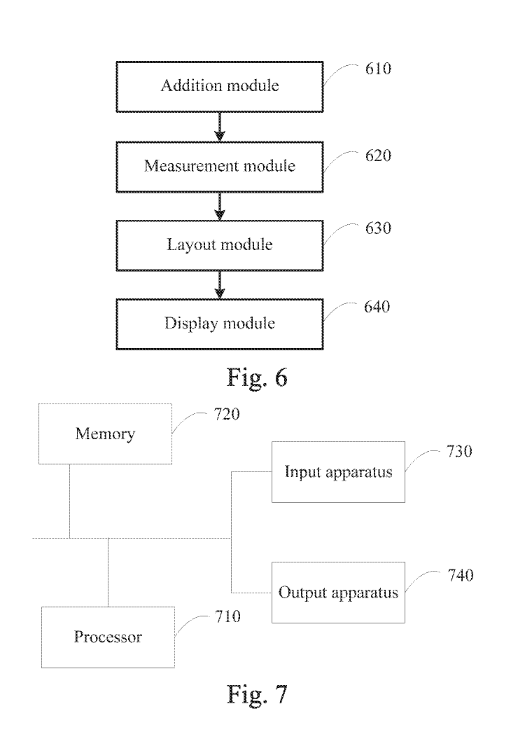

A third implementation manner of this disclosure relates to an animation display apparatus for a view, and as shown in FIG. 6, includes an addition module 610, a measurement module 620, a layout module 630, and a display module 640.

In this implementation manner, the addition module 610 is configured to add respective subviews sequentially to a viewgroup; the measurement module 620 is configured to, when the subview executes a scale-up animation to trigger the viewgroup to perform a layout, measure the respective subviews according to a sequence in an original list (for example, measuring sizes); the layout module 630 is configured to, when the subview executes a scale-up animation to trigger the viewgroup to perform a layout, perform the layout in a sequence in which the subviews are added to the original list of the viewgroup; and the display module 640 is configured to display the respective subviews in the viewgroup, where when the respective subviews are displayed, the subview that executes the scale-up animation is finally displayed.

Specifically, the addition module 610 sequentially adds respective subviews to an original list of a viewgroup; when the subview executes a scale-up animation to trigger the viewgroup to perform a layout, first, the measurement module 620 measures sizes of the respective subviews according to a sequence in the original list, and the layout module 630 arranges, according to results of the measurement of the measurement module 620, the subview first added to the original list of the viewgroup to the subview last added to the original list of the viewgroup in a sequence in which the subviews are added in to the original list of the viewgroup in the addition module 610 from the top to the bottom or from the left to the right in a canvas frame.

Finally, the display module 640 displays the subviews that do not execute a scale-up animation in the canvas frame according to the adding sequence of the respective subviews in the drawing process, and after display of the subviews that do not execute a scale-up animation is completed, finally displays the subview that executes the scale-up animation.

It is not difficult to find that this implementation manner is a system embodiment corresponding to the first and second implementation manners, and this implementation manner may be carried out in cooperation with the first and second implementation manners. Relevant technical details mentioned in the first implementation manner are still effective in this implementation manner, which are not described again herein to reduce repetition. Accordingly, relevant technical details mentioned in this implementation manner may also be applied to the first and second implementation manners.

A fifth implementation manner of this disclosure provides a non-volatile computer storage medium, which stores computer executable instructions, where the computer executable instructions can execute the animation display method for a view in any one of the foregoing method embodiments.

In a schematic structural diagram of hardware of an electronic device for executing an animation display method for a view provided in the fifth implementation manner of this disclosure, as shown in FIG. 7, the device includes:
one or more processors 710 and a memory 720, where only one processor 710 is used as an example in FIG. 7.

A device for executing the animation display method for a view may further include: an input apparatus 730 and an output apparatus 740.

The processor 710, the memory 720, the input apparatus 730, and the output apparatus 740 can be connected by means of a bus or in other manners. A connection by means of a bus is used as an example in FIG. 7.

As a non-volatile computer readable storage medium, the memory 720 can be used to store non-volatile software programs, non-volatile computer executable programs and modules, for example, program instructions/module corresponding to the animation display method for a view in the embodiments of this disclosure (for example, the addition module 610, the measurement module 620, the layout module 630, and the display module 640 shown in FIG. 6). The processor 710 executes various functional applications and data processing of the server, that is, implements the animation display method for a view of the foregoing method embodiments, by running the non-volatile software programs, instructions, and modules that are stored in the memory 720.

The memory 720 may include a program storage area and a data storage area, where the program storage area may store an operating system and an application that is needed by at least one function; the data storage area may store data created according to use of a processing apparatus for displaying a view animation, and the like. In addition, the memory 720 may include a high-speed random access memory, or may also include a non-volatile memory such as at least one disk storage device, flash storage device, or another non-volatile solid-state storage device. In some embodiments, the memory 720 optionally includes memories that are remotely disposed with respect to the processor 710, and the remote memories may be connected, via a network, to the processing apparatus for displaying a view animation. Examples of the foregoing network include but are not limited to: the Internet, an intranet, a local area network, a mobile communications network, or a combination thereof.

The input apparatus 730 can receive entered digits or character information, and generate key signal inputs relevant to user setting and functional control of the processing apparatus for displaying a view animation. The output apparatus 740 may include a display device, for example, a display screen.

The one or more modules are stored in the memory 720; when the one or more modules are executed by the one or more processors 710, the animation display method for a view in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:
(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;
(2) Ultra mobile personal computer device: such devices are essentially personal computers, which have computing and processing functions, and generally have the function of mobile Internet access; terminals of this type include: PDA, MID and UMPC devices, and the like, for example, an iPad;
(3) Portable entertainment device: such devices can display and play multimedia content; devices of this type include: an audio and video player (for example, an iPod), a handheld game console, an e-book, an intelligent toy and a portable vehicle-mounted navigation device;
(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and
(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a server, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. An animation display method for a view, applicable to an electronic device, comprising:
adding respective subviews sequentially to a viewgroup;
when the subview executes a scale-up animation to trigger the viewgroup to perform a layout, performing the layout in a sequence in which the subviews are added to the viewgroup; and
when the respective subviews in the viewgroup are displayed, finally displaying the subview that executes the scale-up animation.

2. The animation display method for a view according to claim 1, wherein the step of performing the layout in a sequence in which the subviews are added to the viewgroup comprises the following sub-step:
arranging the subview first added to the viewgroup to the subview last added to the viewgroup sequentially in a same direction inside a canvas frame.

3. The animation display method for a view according to claim 2, wherein the same direction is a direction from the left to the right; or the same direction is a direction from the top to the bottom.

4. The animation display method for a view according to claim 1, wherein the step of when the respective subviews in the viewgroup are displayed, finally displaying the subview that executes the scale-up animation comprises:
displaying subviews that do not execute a scale-up animation in a sequence in they are added to the viewgroup; and
after display of the subviews that do not execute a scale-up animation is completed, displaying the subview that executes the scale-up animation.

5. The animation display method for a view according to claim 1, wherein the step of when the respective subviews in the viewgroup are displayed, finally displaying the subview that executes the scale-up animation comprises:
when the subview executes the scale-up animation to trigger the viewgroup to perform a layout, adjusting an adding sequence of the subview that executes the scale-up animation to the last; and
in the step of displaying the respective subviews in the viewgroup, displaying the respective subviews in the canvas frame according to an adding sequence of the respective subviews in the drawing process.

6. The animation display method for a view according to claim 1, further comprising:
before performing layout on the respective subviews, first measuring sizes of the respective subviews; and
according to results of the measurement, performing the layout in a sequence in which the subviews are added to the viewgroup.

7-11. (canceled)

12. A non-volatile computer storage medium, which stores computer executable instructions, that when executed by an electronic device, cause the electronic device to:
add respective subviews sequentially to a viewgroup;
when the subview executes a scale-up animation to trigger the viewgroup to perform a layout, perform the layout in a sequence in which the subviews are added to the viewgroup; and
when the respective subviews in the viewgroup are displayed, finally display the subview that executes the scale-up animation.

13. The non-volatile computer storage medium according to claim 12, wherein the instructions to perform the layout in a sequence in which the subviews are added to the viewgroup cause the electronic device to:
arrange the subview first added to the viewgroup to the subview last added to the viewgroup sequentially in a same direction inside a canvas frame.

14. The non-volatile computer storage medium according to claim 13, wherein the same direction is a direction from the left to the right; or the same direction is a direction from the top to the bottom.

15. The non-volatile computer storage medium according to claim 12, wherein the instructions to, when the respective subviews in the viewgroup are displayed, finally display the subview that executes the scale-up animation cause the electronic device to:
display subviews that do not execute a scale-up animation in a sequence in they are added to the viewgroup; and
after displaying of the subviews that do not execute a scale-up animation is completed, display the subview that executes the scale-up animation.

16. The non-volatile computer storage medium according to claim 12, wherein the instructions to, when the respective subviews in the viewgroup are displayed, finally display the subview that executes the scale-up animation cause the electronic device to:
when the subview executes the scale-up animation to trigger the viewgroup to perform a layout, adjust an add sequence of the subview that executes the scale-up animation to the last; and
in the instructions to display the respective subviews in the viewgroup, display the respective subviews in the canvas frame according to an adding sequence of the respective subviews in the drawing process.

17. The non-volatile computer storage medium according to claim 12, further cause the electronic device to:
before performing layout on the respective subviews, first measure sizes of the respective subviews; and
according to results of the measurement, perform the layout in a sequence in which the subviews are added to the viewgroup.

18. An electronic device, comprising:
at least one processor; and
a memory communicably connected with the at least one processor for storing instructions executable by the at least one processor, wherein execution of the instructions by the at least one processor causes the at least one processor to:
add respective subviews sequentially to a viewgroup;
when the subview executes a scale-up animation to trigger the viewgroup to perform a layout, perform the layout in a sequence in which the subviews are added to the viewgroup; and
when the respective subviews in the viewgroup are displayed, finally display the subview that executes the scale-up animation.

19. The electronic device according to claim 18, wherein the execution of the instructions to perform the layout in a sequence in which the subviews are added to the viewgroup cause the at least one processor to:
arrange the subview first added to the viewgroup to the subview last added to the viewgroup sequentially in a same direction inside a canvas frame.

20. The electronic device according to claim 19, wherein the same direction is a direction from the left to the right; or
the same direction is a direction from the top to the bottom.

21. The electronic device according to claim 18, wherein the execution of the instructions to, when the respective subviews in the viewgroup are displayed, finally display the subview that executes the scale-up animation cause the at least one processor to:
display subviews that do not execute a scale-up animation in a sequence in they are added to the viewgroup; and
after displaying of the subviews that do not execute a scale-up animation is completed, display the subview that executes the scale-up animation.

22. The electronic device according to claim 18, wherein the execution of the instructions to, when the respective subviews in the viewgroup are displayed, finally display the subview that executes the scale-up animation cause the at least one processor to:
when the subview executes the scale-up animation to trigger the viewgroup to perform a layout, adjust an adding sequence of the subview that executes the scale-up animation to the last; and
in the step of displaying the respective subviews in the viewgroup, display the respective subviews in the canvas frame according to an adding sequence of the respective subviews in the drawing process.

23. The electronic device according to claim 18, further cause the at least one processor to:
before performing layout on the respective subviews, first measure sizes of the respective subviews; and
according to results of the measurement, perform the layout in a sequence in which the subviews are added to the viewgroup.
